(19) United States
(12) Patent Application Publication
(10) Pub. No.: US 2010/0156314 A1
(43) Pub. Date: Jun. 24, 2010

(54) Light source driver circuit

(75) Inventors: Yen-Hui Wang, Hsinchu (TW); Chia-Chieh Hung, Hsinchu (TW); Chi-Hao Wu, Hsinchu (TW)

Correspondence Address: YEN-HUI WANG, P.O. Box 44-2049, Taipei, 10668, TW

(73) Assignee: Grenergy Opto, Inc.

(21) Appl. No.: 12/318,067

(22) Filed: Dec. 22, 2008

(51) Int. Cl. H05B 37/00

(52) U.S. Cl. 315/294

(57) ABSTRACT

A light source driver circuit includes a voltage input terminal, a light source module, a transformer module, a voltage regulator module, a first switch and a control module. The voltage input terminal receives an input voltage. The light source module includes a plurality of light-emitting units. The transformer module is electrically connected to the light-emitting units. The voltage regulator module connected to the voltage input terminal provides a stable output voltage. The first switch electrically connected to the transformer module and the voltage regulator module receives the stable output voltage to determine whether the first switch is to be turned on or off. The control module is electrically connected to the first switch. The control module and the first switch are controlled so that the light source module the input voltage can be drived by the input voltage.

### BACKGROUND OF THE INVENTION

(1) Field of the Invention

The invention relates to a light source driver circuit, and more particularly to a light source driver circuit, which determines whether to drive a light source or not using at least one switch and a control module.

(2) Description of the Prior Art

In the prior art, a control circuit for controlling a light-emitting diode (LED) includes a controller and an electronic switch Q, as shown in FIG. 1. In this circuit, a control unit controls the on/off state of the electronic switch Q so that the LED can be turned on. However, the input voltage Vi enables the inductor L or the transformer when the voltage is inputted so that the high voltage is generated. A high-voltage resistant control unit has to be used to prevent the control unit from being damaged. However, the high-voltage resistant control unit increases the device cost. If the high-voltage resistant control unit is not used, other device elements may be damaged.

In view of this, a light source driver circuit is required to eliminate the drawback of the prior art.

### SUMMARY OF THE INVENTION

The invention provides a light source driver circuit, which determines whether to drive a light source or not using at least one switch and/or a control module.

In addition, the invention provides a light source driver circuit, in which a transformer module drives a plurality of light sources, and a surge voltage protection device is provided to prevent a control module from being damaged so that the surge voltage is only associated with an external element.

Furthermore, the invention provides a light source driver circuit, in which a first switch serves as a starting device, and a signal generator is provided to control a second switch so that the high efficiency driving can be obtained.

In one embodiment, the invention provides a light source driver circuit, which includes a voltage input terminal, a light source module, a transformer module, a voltage regulator module, a first switch and a control module. The voltage input terminal receives an input voltage. The light source module includes a plurality of light-emitting units. The transformer module is electrically connected to the plurality of light-emitting units. The voltage regulator module connected to the voltage input terminal provides a stable output voltage. The first switch electrically connected to the transformer module and the voltage regulator module receives the stable output voltage, and determines whether to turn on the first switch or not. The control module is electrically connected to the first switch. The control module and the first switch are controlled so that the input voltage can drive the light source module.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 shows a circuit diagram according to the prior art.

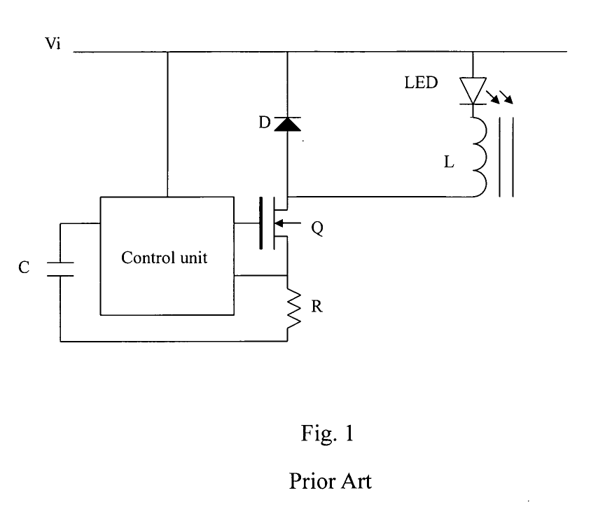

FIG. 2 is a block diagram showing a light source driver circuit.

FIG. 3 is a circuit diagram showing the light source driver circuit.

### DETAILED DESCRIPTION OF THE PREFERRED EMBODIMENTS

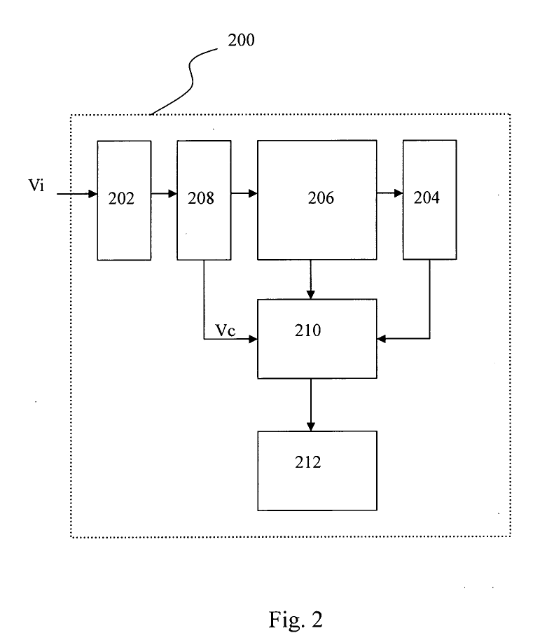

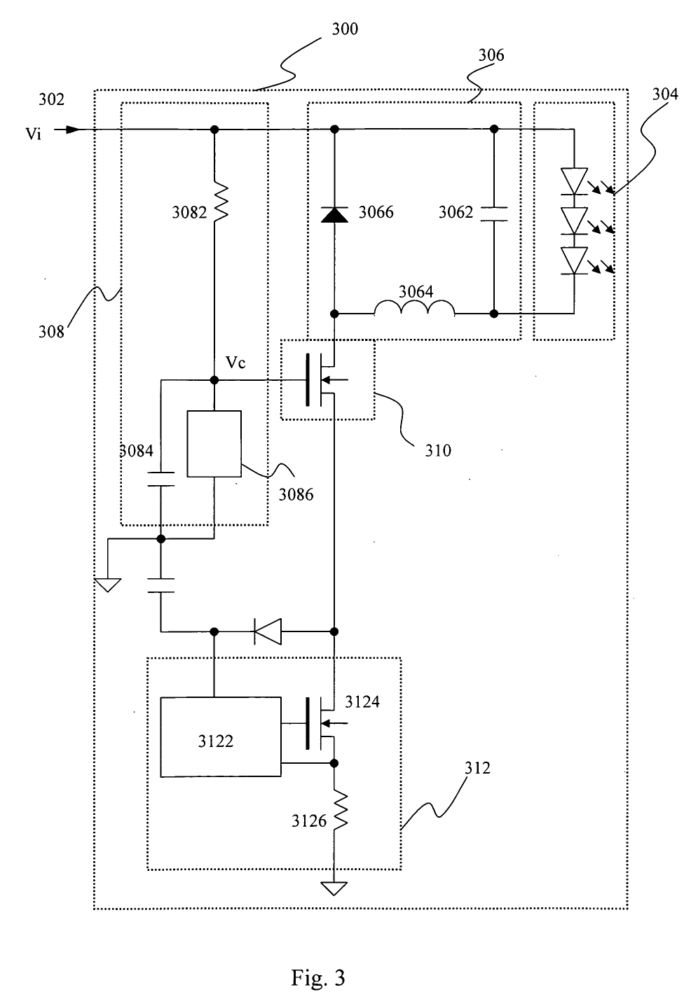

The invention discloses a light source driver circuit, in which at least one switch and/or a control module may be provided to determine whether to drive a light source or not, a transformer module is provided to drive a plurality of light sources, and a surge voltage protection device is provided to prevent the control module from being damaged so that the surge voltage is only associated with an external element. In order to complete the description of the invention, illustrations will be made with reference to FIG. 2 and FIG. 3.

FIG. 2 is a block diagram showing a light source driver circuit 200. In this embodiment, the light source driver circuit 200 includes a voltage input terminal 202, a light source module 204, a transformer module 206, a voltage regulator module 208, a first switch 210 and a control module 212. The voltage input terminal 202 receives an input voltage Vi, which is, for example, a DC voltage or a DC voltage generated after an AC voltage is rectified, wherein the AC voltage is mainly 110 or 220 volts, and is rectified by a half-wave rectifier or a full-wave bridge rectifier. The light source module 204 includes a plurality of light-emitting units, which includes, for example, cascaded light-emitting diodes, cascaded organic light-emitting diodes or cascaded lamps. The transformer module 206 electrically connected to the light-emitting units drives a plurality of light sources or prevents the damage caused by the surge voltage. For example, the transformer module 206 is a positive booster module, a negative booster module, a positive-negative booster module, a negative-positive booster module or other combinations. The voltage regulator module 208 connected to the voltage input terminal 202 provides a stable output voltage Vc. The first switch 210 electrically connected to the transformer module 206 and the voltage regulator module 208 receives the stable output voltage Vc to determine whether the first switch 210 is to be turned on or off. For example, a high-voltage resistant metal-oxide-semiconductor field-effect transistor (MOSFET) or a high-voltage resistant transistor (BJT) may serve as the first switch 210. The control module 212 is electrically connected to the first switch 210. The on/off states of the control module 212 and the first switch 210 may be controlled so that the input voltage Vi drives the light source module 204.

More particularly, the control of the control module 212 may be implemented by using a lower voltage control device and may further be effectively controlled in conjunction with a second switch (not shown) so that the efficient driving can be achieved. In addition, if the instantaneously too-high voltage is inputted in this embodiment, it is possible to ensure that the control module 212 is free from being damaged.

FIG. 3 is a circuit diagram showing a light source driver circuit. Referring to FIG. 3, a light source driver circuit 300 is provided in this embodiment. The light source driver circuit 300 includes a voltage input terminal 302, a light source module 304, a transformer module 306, a voltage regulator module 308, a first switch 310 and a control module 312. The voltage input terminal 302 receive the input voltage Vi. The light source module 304 includes a plurality of light-emitting units, such as three light-emitting diodes connected in series. The transformer module 306 electrically connected to the light-emitting units drives a plurality of light sources or prevents the damage caused by the surge voltage. For example, the transformer module 306 is a positive booster module, a negative booster module, a positive-negative booster module, a negative-positive booster module or other combinations. The transformer module 306 is composed of a first capacitor 3062, an inductor 3064 and a diode 3066. Preferably, the first capacitor 3062 is connected to the light source module 304 in parallel, and the diode 3066 is electrically connected to the first capacitor 3062 and the plurality of light-emitting units via the inductor 3064. The voltage regulator module 308 is connected to the voltage input terminal 302 and provides the stable output voltage Vc. The voltage regulator module 308 is composed of a first resistor 3082, a second capacitor 3084 and a regulator device 3086, wherein the regulator device 3086 is a Zener diode. Preferably, the second capacitor 3084 is connected to the regulator device 3086 in parallel. The first switch 310 electrically connected to the transformer module 306 and the voltage regulator module 308 receives the stable output voltage Vc to determine whether the first switch 310 is to be turned on or off. For example, the first switch 310 is composed of a MOSFET having a drain, a gate and a source, wherein the gate receives the stable output voltage. Alternatively, the first switch 310 is composed of a transistor (BJT) having a collector, a base and an emitter, wherein the base receives the stable output voltage (not shown). The control module 312 is electrically connected to the first switch 310. The control module 312 includes a signal generator 3122, a second switch 3124 and a second resistor 3126. Preferably, the signal generator 3122 generates a control signal for controlling the second switch 3124, wherein signal generator 3122 may be, for example, a pulse width modulation (PWM) signal generator, a constant-on time signal generator or a constant-off time signal generator for generating a modulation signal. In addition, the control module 312 may also detect the voltage or current of the second resistor 3126 to enable the signal generator 3122 to generate the control signal. Preferably, the second switch 3124 is composed of a MOSFET having a drain, a gate and a source, wherein the gate receives the control signal of the control module 312. Alternatively, the second switch 3124 is composed of a transistor having a collector, a base and an emitter, wherein the base receives the control signal of the control module 312.

The input voltage Vi may be generated from the mains, a primary battery or a secondary battery. If the mains (AC power) are rectified by a rectifier circuit, the voltage or the current for driving the light source module 304 can be generated. The divided voltage is generated through the voltage regulator module 308. At the beginning, the regulator device 3086 has not yet entered the breakdown region to generate the breakdown voltage, and the input voltage Vi firstly charges the second capacitor 3084. When the voltage across two ends of the charged second capacitor 3084 is higher than the reverse bias voltage for enabling the regulator device 3086 to work, the regulator device 3086 is held at a certain constant voltage to provide the bias voltage for turning on the first switch 310. When the load needs the higher current, the current flowing through the regulator device 3086 is decreased. On the contrary, when the load needs the lower current, the current flowing through the regulator device is increased. Because the influence of the flowing current on the potential difference between two ends of the regulator device is very small, the voltage regulating effect can be achieved.

Meanwhile, the input voltage Vi is provided to the transformer module 306 and the light source module 304. However, the control module 312 has not yet controlled the second switch 3124 to turn on, so the transformer module 306 and the light source module 304 also have not yet been turned on. When the control module 312 turns on the second switch 3124, the input voltage Vi is provided to the transformer module 306 and the light source module 304. At this time, if the input voltage Vi is at the other half-wave, a doubled voltage (the input voltage Vi plus the back electromotive force generated by the inductor) is generated at the transformer module 306 and the light source module 304. At this time, a surge voltage protection device (the diode 3066) is provided to prevent the control module 312 from being damaged so that the surge voltage is only associated with the light source module 304.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A light source driver circuit, comprising:
a voltage input terminal for receiving an input voltage;
a light source module comprising a plurality of light-emitting units;
a transformer module electrically connecting to the plurality of light-emitting units;
a voltage regulator module connecting to the voltage input terminal, and providing a stable output voltage;
a first switch electrically connecting to the transformer module and the voltage regulator module, receiving the stable output voltage and determining whether the first switch is to be turned on or off; and
a control module electrically connecting to the first switch, wherein the on/off states of the control module and the first switch are controlled so that the input voltage drived the light source module.

2. The light source driver circuit according to claim 1, wherein the plurality of light-emitting units comprise cascaded light-emitting diodes, cascaded organic light-emitting diodes or cascaded lamps.

3. The light source driver circuit according to claim 2, wherein the transformer module comprises a positive booster module, a negative booster module, a positive-negative booster module or a negative-positive booster module.

4. The light source driver circuit according to claim 3, wherein the transformer module is composed of a first capacitor, an inductor and a diode.

5. The light source driver circuit according to claim 4, wherein the first capacitor is connected to the light source module in parallel.

6. The light source driver circuit according to claim 4, wherein the diode is electrically connected to the first capacitor and the plurality of light-emitting units via the inductor.

7. The light source driver circuit according to claim 1, wherein the voltage regulator module is composed of a first resistor, a second capacitor and a voltage regulator device.

8. The light source driver circuit according to claim 7, wherein the voltage regulator device is a Zener diode.

9. The light source driver circuit according to claim 7, wherein the second capacitor is connected to and, the Zener diode in parallel.

10. The light source driver circuit according to claim 1, wherein the first switch is composed of a metal-oxide-semiconductor field-effect transistor (MOSFET).

11. The light source driver circuit according to claim 10, wherein the MOSFET has a drain, a gate and a source, and the gate receives the stable output voltage.

12. The light source driver circuit according to claim 1, wherein the first switch is composed of a transistor (BJT).

13. The light source driver circuit according to claim 12, wherein the transistor has a collector, a base and an emitter, and the base receives the stable output voltage.

14. The light source driver circuit according to claim 1, wherein the control module comprises a signal generator and a second switch.

15. The light source driver circuit according to claim 14, wherein the signal generator generates a control signal for controlling the second switch.

16. The light source driver circuit according to claim 15, wherein the signal generator is a pulse width modulation (PWM) signal generator, a constant-on time signal generator or a constant-off time signal generator.

17. The light source driver circuit according to claim 14, wherein the control module detects a voltage or a-current of a second resistor.

18. The light source driver circuit according to claim 14, wherein the second switch is composed of a metal-oxide-semiconductor field-effect transistor (MOSFET), which has a drain, a gate and a source, and the gate receives a control signal of the control module.

19. The light source driver circuit according to claim 14, wherein the second switch is composed of a transistor, which has a collector, a base and an emitter, and the base receives a control signal of the control module.
